(19) United States
(12) Patent Application Publication
(10) Pub. No.: US 2010/0088177 A1
(43) Pub. Date: Apr. 8, 2010

(54) SEGMENT OPTIMIZATION FOR TARGETED ADVERTISING

(75) Inventors: Quan LU, Belmont, CA (US); Xuhui SHAO, Palo Alto, CA (US); Goutham KURRA, San Francisco, CA (US); Dominic BENNETT, Los Altos, CA (US)

Correspondence Address: GLENN PATENT GROUP, 3475 EDISON WAY, SUITE L, MENLO PARK, CA, 94025, US

(73) Assignee: TURN INC., Redwood City, CA (US)

(21) Appl. No.: 12/617,590

(22) Filed: Nov. 12, 2009

Related U.S. Application Data
(63) Continuation-in-part of application No. 12/410,400, filed on Mar. 24, 2009.
(60) Provisional application No. 61/102,317, filed on Oct. 2, 2008.

(51) Int. Cl. G06Q 30/00; G06Q 10/00

(52) U.S. Cl. 705/14.43; 705/1.1

(57) ABSTRACT

A system for generating behavior segments and serving targeted ads. The system generates variables based on data from targeted users, incorporates recency, frequency, and velocity for the variables; optimizes the variables; converts the variables into behavior segments; and saves the behavior segments to a database. The system updates the behavior segments in real time. When a publisher requests an ad call, the system generates a score for advertisements based on the user profile, multiplies the score by the amount each advertiser is willing to pay for serving their ad, selects the highest value, and serves the ad.

### CROSS REFERENCE TO RELATED APPLICATIONS

This patent application is a continuation-in-part of U.S. patent application Ser. No. 12/410,400, Predicting User Response to Advertisements, filed Mar. 24, 2009, which claims priority to U.S. provisional patent application Ser. No. 61/102,317, Turn Segment (Rule) Builder Requirements, filed Oct. 2, 2008, the entirety of each of which is incorporated herein by this reference thereto.

### BACKGROUND OF THE INVENTION

1. Technical Field

This invention relates generally to the field of targeted advertisements. More specifically, this invention relates to the process for predicting behavior in response to targeted advertisements.

2. Description of the Related Art

The Internet is quickly becoming a primary source for providing media. More news is now read online than in print media. Videos and television shows are increasingly watched through online applications, such as Hulu, Netflix, and YouTube.

Although the system of advertising in print media has been well-established for centuries, the rules for online advertising are still being developed. As users demand instant access to entertainment their patience for advertisements rapidly dwindles. If a user is forced to watch a pre-roll before a video is displayed, for example, the user may simply click on another window or walk away from the display screen until the advertisement is gone. If users are not watching the advertisement, the publisher is not receiving the maximum advertising revenue.

One way to encourage users to watch the advertisements is to target the advertisements to the users' interests. Google monetizes YouTube videos by placing overlays on the video that match the subject matter of the video and/or the website that displays the video. The advertisements, however, lack personalization.

Personalized advertisements are typically based on information that is easily gleaned about a user. For example, the IP address associated with the user's computer provides geographical information about the user. The company may also be able to determine the user's gender, age, and career. As a result, the advertisement is more likely to appeal to the user if it is targeted for age, gender, and location.

Advertisements are further personalized by analyzing a user's Internet search history to determine user behavior. For example, a user that is searching for jewelry is more likely to purchase jewelry than a user that is searching for puppies. By combining the subject matter of a website visited by a user with the user's personal information and the user's Internet search history, a more complete picture of the user begins to emerge.

Advertisers, however, do not want to only target people that they know are shopping for their product. There is also a group of people that are likely to purchase a product even though they are not currently shopping for the product. At this point, the issue becomes how to identify users that are more likely to purchase a particular product or service even though little data exists to directly connect the user to the product. One solution is to use a lookalike model, which compares an individual user with similar users to identify trends and predict how the individual user will behave. The challenge is to develop an accurate predictive model.

The predictive model typically resides on the ad server that serves the ads to the publisher. The ad server comprises a repository of advertisements and a repository of user profile information. The user profile information is identified with a unique identification, based on an IP address, etc. The ad server receives a request for an advertisement from a publisher, compares the user profile to the advertisements, and selects an ad that is most likely to be successful. Success can be defined in a variety of ways including a click-through, placing an item in a shopping card, a registration, a purchase, etc. As the amount of user information increases, the processing time for selecting a targeted advertisement also increases. As a result, these prior art systems are not equipped to handle large amounts of data.

What is needed is a method for creating behavioral segments quickly that accurately predict user behavior.

### SUMMARY OF THE INVENTION

The present invention overcomes the deficiencies and limitations of the prior art by providing a system and method for generating behavior segments and serving targeted ads. The system generates variables based on data from targeted users, incorporates recency and frequency requirements for the variables, optimizes the variables, converts the variables into behavior segments, and saves the behavior segments. The system updates the behavior segments in real time. When a publisher requests an ad call, the system generates a score for advertisements based on the user profile, multiplies the score by the amount each advertiser is willing to pay for serving their ad, selects the highest value, and serves the ad.

### BRIEF DESCRIPTION OF THE DRAWINGS

FIG. 1 is a block diagram that illustrates a predictive behavior system;

FIG. 2A is a block diagram of an embodiment that illustrates a memory of the predictive behavior system;

FIG. 2B is a block diagram that illustrates a distributed server system;

FIG. 3 is a block diagram that illustrates system components for a segment generation process;

FIG. 4 is a flow diagram that illustrates the steps for generating segments;

FIG. 5A is an illustration of a two-variable problem;

FIG. 5B is a second illustration of the two-variable problem;

FIG. 6 is a block diagram that illustrates lift as a function of the targeted audience in a single-variable and multi-variable optimization process;

FIG. 7 is a flow diagram that illustrates the steps for refreshing segments; and

FIG. 8 is a flow diagram that illustrates the steps for serving ads during runtime.

### DETAILED DESCRIPTION OF THE INVENTION

A method and apparatus for generating predictive behavior segments and serving targeted advertisements is described below.

### System Architecture

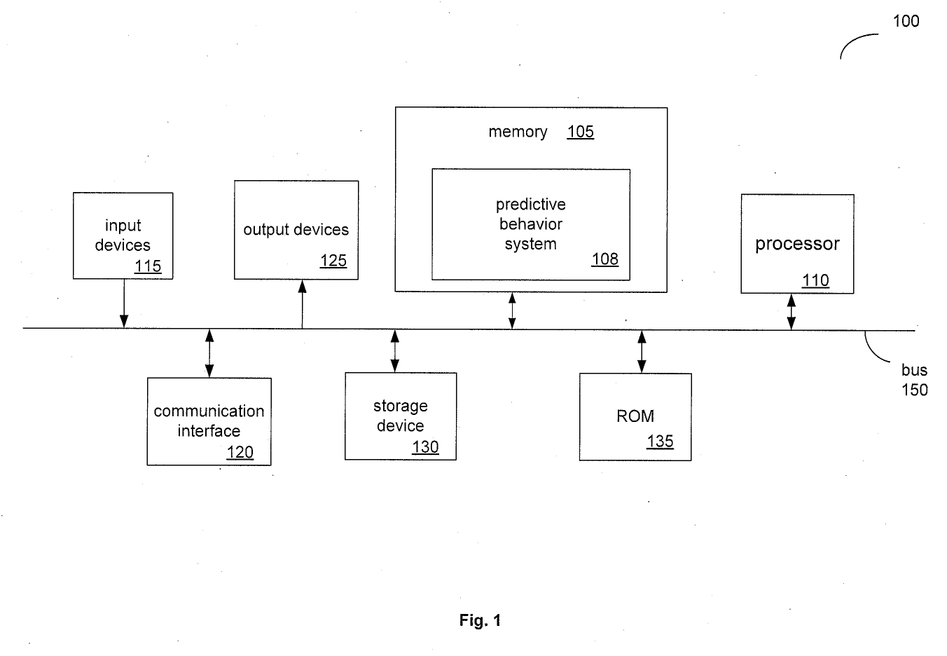

In one embodiment, the client 100 comprises a computing platform configured to act as a client device, e.g. a personal computer, a notebook, a smart phone, a laptop, a personal digital assistant, etc. FIG. 1 is a block diagram of a client 100 according to one embodiment of the invention. The client 100 includes a bus 150, a processor 110, a main memory 105, a read only memory (ROM) 135, a storage device 130, one or more input devices 115, one or more output devices 125, and a communication interface 120. The bus 150 includes one or more conductors that permit communication among the components of the client 100.

The processor 110 includes one or more types of conventional processors or microprocessors that interpret and execute instructions. Main memory 105 includes random access memory (RAM) or another type of dynamic storage device that stores information and instructions for execution by the processor 205. ROM 135 includes a conventional ROM device or another type of static storage device that stores static information and instructions for use by the processor 110. The storage device 130 includes a magnetic and/or optical recording medium and its corresponding drive.

Input devices 115 include one or more conventional mechanisms that permit a user to input information to a client 100, such as a keyboard, a mouse, etc. Output devices 125 include one or more conventional mechanisms that output information to a user, such as a display, a printer, a speaker, etc. The communication interface 120 includes any transceiver-like mechanism that enables the client 100 to communicate with other devices and/or systems. For example, the communication interface 120 includes mechanisms for communicating with another device or system via a network.

The software instructions that define the predictive behavior system 108 are to be read into memory 105 from another computer readable medium, such as a data storage device 130, or from another device via the communication interface 120. The processor 110 executes computer-executable instructions stored in the memory 105. The instructions comprise product code generated from any compiled computer-programming language, including, for example, C, C++, C# or Visual Basic, or source code in any interpreted language such as Java or JavaScript.

The client 100 receives information from various sources over a network. The network can be a wired network, such as a local area network (LAN), a wide area network (WAN), a home network, etc., or a wireless local area network (WLAN), e.g. Wifi, or wireless wide area network (WWAN), e.g. 2G, 3G, 4G.

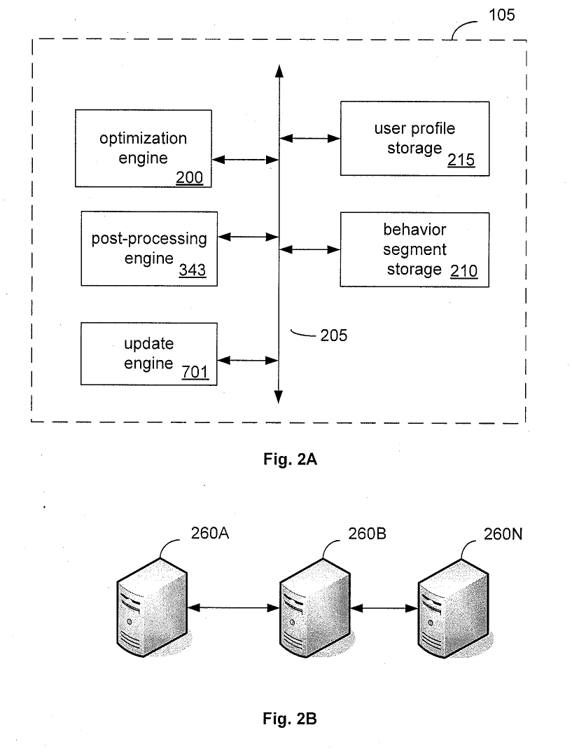

FIG. 2A illustrates one embodiment of the memory 105. The optimization engine 200 is coupled to a bus 205. The user profile storage 210 and the behavior segment storage 215 are also coupled to the bus 205. Although the user profiles and the behavior segments are illustrated as being stored in separate storage locations, persons of ordinary skill in the art will recognize that the information can be stored together or further divided into additional storage locations.

FIG. 2B illustrates a parallel-processing embodiment of the invention that functions on a distributed-server system. In one embodiment, each server (260A, 260B, 260N) contains an optimization engine 200, user profile storage 215, and behavior segment storage 210. The servers are connected over a network. Each server generates' behavior segments for a product. When publishers request ad calls, the each request is sent to a different server for processing. This improves efficiency and decreases the processing time because each server responds to the request immediately instead of forming a queue of requests.

In another embodiment, each server contains various combinations of an optimization engine 200, user profile storage 215, and behavior segment storage 210. For example, one server 260A contains an optimization engine 200 for generating a variable list and another server 260B contains the behavior segment storage 210.

### Generating the Behavior Targeting Segments

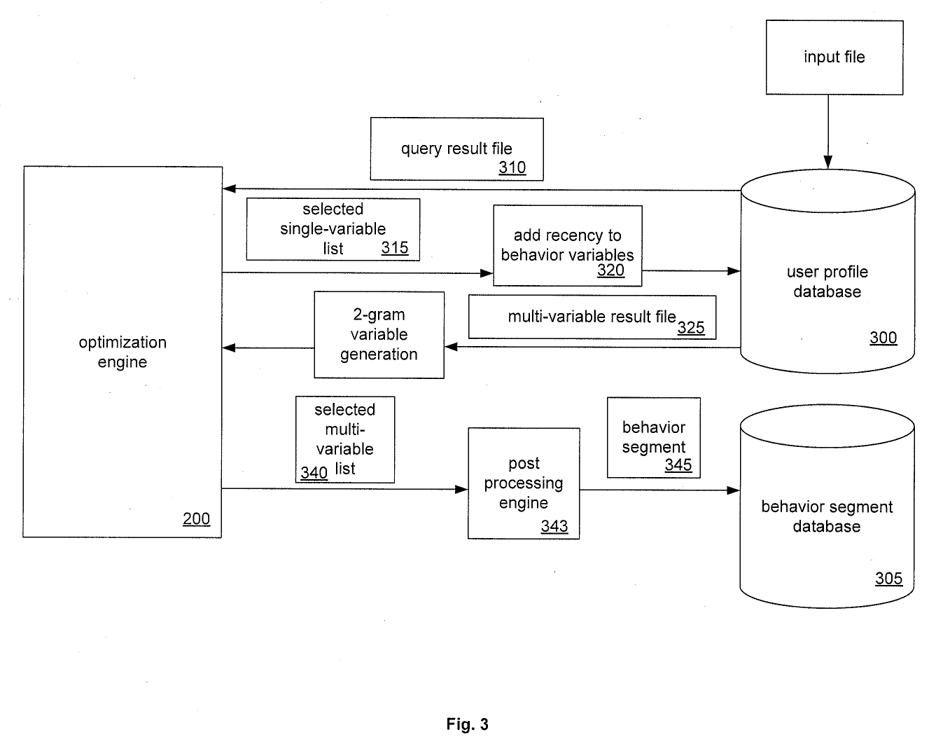

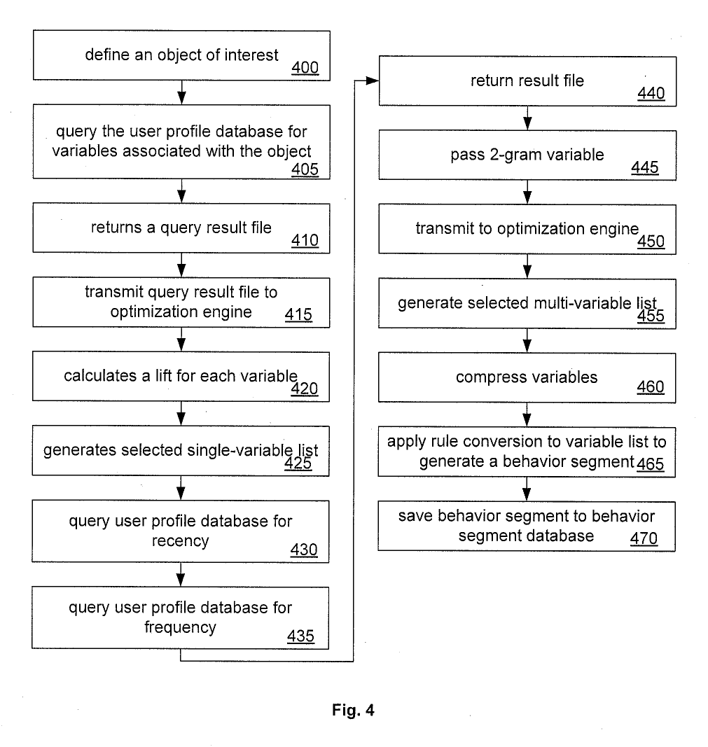

FIG. 3 illustrates the transmission of information between the optimization engine, the user profile storage 215, and the behavior segment storage 210 during the behavior segment generation process according to one embodiment of the invention. FIG. 4 illustrates the flow diagram that corresponds to the steps illustrated in FIG. 3.

Previous approaches to behavior segment generation focus on similarities between new users and users who are known to be interested in the product or its advertisement. This approach is problematic, however, because even carefully chosen similarity measures such as age, income and gender are rarely clear indicators of consumer behavior, let alone indicators of a user's propensity to purchase certain brands of products and services.

Thus, in one embodiment, the system generates a small number of variables that are relevant to a product, advertisement, or target population based on the variable's predictive power to consumer's propensity to that product, advertisement or association to the target population. The variables are combined to form rules. The rules are combined to form a behavior segment for the product, advertisement, or target population. The segments are standardized and incorporated into the overall machine learning model so that the expected value of each advertising impression to the advertisers can be more accurately predicted.

Using a small number of essential variables decreases the computational strain on the optimization engine 200 during the behavior segment generation process. If, for example, the advertisement is for yoga mats, the variables identify people that are interested in fitness. This encompasses not only someone that purchases gym shoes, workout clothing, and yoga blocks, but also more tangential yet statistically significant connections such as someone that researches healthy eating.

A client defines 400 a product of interest. The client queries 405 the user profile database 300 for variables associated with the product. The user profile database 300 contains information derived from a variety of sources including Internet searches, histories, and purchases.

The variables are expressed in a variety of ways including beacons, Boolean logic, proxies, demographics, third-party events, and composites. Beacons identify the activities of purchasers. For example, users that purchased a computer two years ago may be ready to purchase another one. Boolean logic is used to define the activities of non-purchasers, such as all users that shopped for shoes and Nike® products. Proxy is used when a new product is being introduced. Proxy identifies non-purchasers that are likely to purchase the new product. For example, early adopters of technology, such as users that bought the first iPhone® are more likely to purchase the Amazon® Kindle. Demographics are user information like gender, age, and house hold income. Third-party events are user's events recorded by third-party data partners, for example, a user is tagged as “Auto intenders” when certain automotive related events are reported for this user. Composites are a combination of two different behavior segments. For example, the behavior segment for fitness people is combined with a behavior segment for stay-at-home mothers to obtain a behavior segment composite for stay-at-home mothers that are interested in fitness.

The user profile database 300 returns 410 a query result file 310 that contains a variable list, a number of targeted users, and a number of non-targeted users for each variable. The query result file is transmitted 415 from the user profile database 300 to the optimization engine 200. The optimization engine 200 calculates 420 a lift for each variable. The lift defines the response rate of a targeted audience as compared to the response rate of the audience in general. When applied to targeted segments, the equation is defined as:

Lift=(Sₜ/Nₜ)/(Sₙ/Nₙ) Eq. (1)

where Sₜ is the number of targeted users that responded positively to a product or advertisement, Nₜ is the number of targeted users overall; Sₙ is the number of non-targeted users that responded positively to a product, and Nₙ is the overall non-targeted number of users.

In one embodiment, lift is calculated based on multiple variables where the variables are organized in decreasing order of likelihood of generating a response from a user. Thus, the lower the lift, the larger the audience. For example, in the query result file 310, the first variable is associated with a 1% response ( 1/100) as compared with 0.1% ( 1/1000) of the general population, thereby resulting in a 10× lift. The next variable is associated with a 0.5% ( 5/1000) response as compared with 0.1% ( 1/1000) of the general population. Thus, when the two variables are combined as a segment to reach a larger amount of the population ( 6/1000), the lift decreases to 7.5×.

As the lift decreases, the percentage of responses decreases as well. Targeting a large audience is irrelevant if the audience is unlikely to respond to the advertisement. As a result, the optimization engine 200 generates 425 a selected single-variable list 340 by optimizing the variables as a function of the lift and a target audience. The selected single-variable list 340 is a balance between the desired size of the audience and the effectiveness of the variables to obtain a segment with the proper lift.

In one embodiment of the invention, the optimization engine 200 uses KS during optimization. KS is a stopping criteria that controls the segment complexity. KS is defined by the following equation:

KS=(Sₜ/Nₜ)−(Sₙ/Nₙ) Eq. (2)

where Sₜ is the number of targeted users that responded positively to a product or advertisement, Nₜ is the number of targeted users overall, Sₙ is the number of non-targeted users that responded positively to a product or advertisement, and Nₙ is the overall non-targeted number of users.

KS divides user reactions into positive and negative samples. The KS metric is used to identify the point at which the separation between samples no longer increases. The solution is to find a minimal number of variable combinations that cover all users. At this point, the optimization engine 200 completes the optimization process.

One way to express the rules is through a greedy heuristic algorithm:

while( ){

select the best variable combination as one with the largest value:
# of target / # of non-target users covered by it.
If (bring the best variable combination to the final set increases the
accumulative KS of the final set)

set the best variable combination to the final set.

else

exit the loop

}

The selected single-variable list 315 is further narrowed and made more relevant by querying 430 the user profile database for a multi-variable result file 325 that includes recency. Recency is defined as the amount of time that has elapsed since an action took place. For example, advertisers are more interested in people that shopped for a product in the last week or month. Advertisers want to identify people that are getting ready to purchase shoes, and therefore are more interested in people that shopped for shoes in the last week.

In one embodiment, the selected variable list 315 is further narrowed by querying 435 the user profile database 305 for a frequency of activity and a velocity of activity. Frequency measures the number of times that a person performs a certain activity. Velocity measures the frequency over time. For example, if the user visits a website once on Monday, twice on Tuesday, and four times on Thursday, the velocity is increasing. The user profile database 300 returns 440 a multi-variable result file 325.

A two-gram variable generation process is passed 445 to the optimization engine 200 along with the result file 325. A two-gram variable generation process is a probabilistic model for predicting the next item based on the last two variables. While the first pass in the optimization engine 200 uses only a single variable, the two-variable process generates many more interaction combinations. Persons of ordinary skill in the art will recognize that other variables can be used based on the n-gram variable generation process.

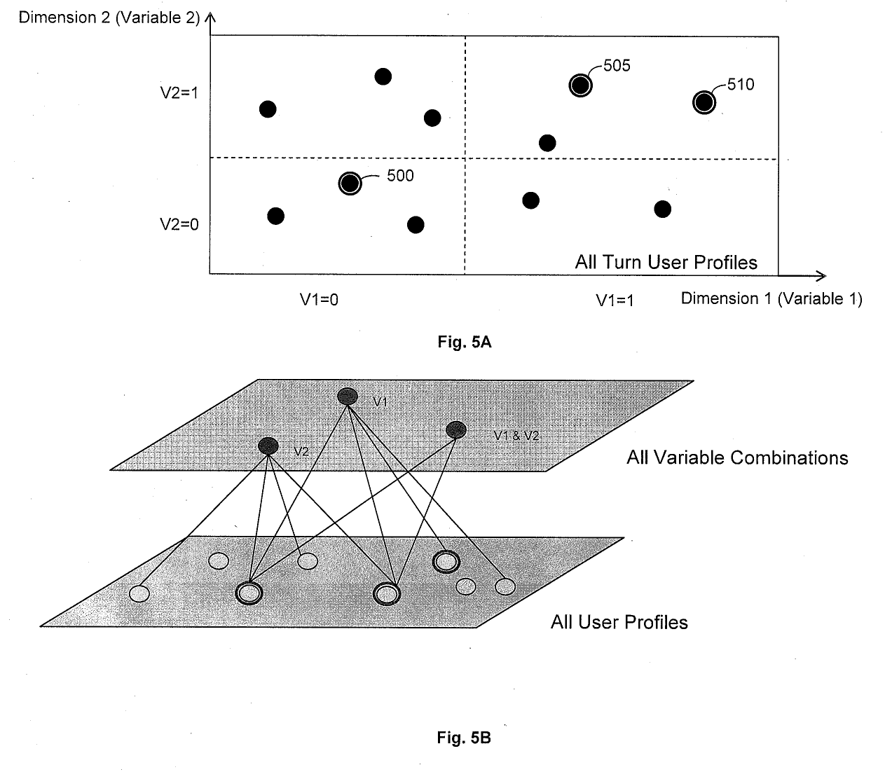

FIG. 5A illustrates a two-variable example according to one embodiment of the invention. The y-axis shows the incidence of users that match the second variable. The x-axis shows the incidence of users that match the first variable. Data are obtained from the Turn user profiles. The data points with an outer circle 500, 505, 510 are targeted users. The other data points represent users that do not match the two variables. Thus, the solution is either v1=0 and v2=0 or v1=1 and v2=1.

FIG. 5B illustrates the variable combinations as mapped to the user profiles. The goal is to determine a set of variable combinations that cover a set of users with a maximal KS.

The optimization engine 200 generates 455 a selected multi-variable list 340 based on the modified data. Persons of ordinary skill in the art will recognize that although this is described as a two-step optimization process, the recency and frequency variables can be added to the query result file 310 and passed through the optimization engine 200 a single time.

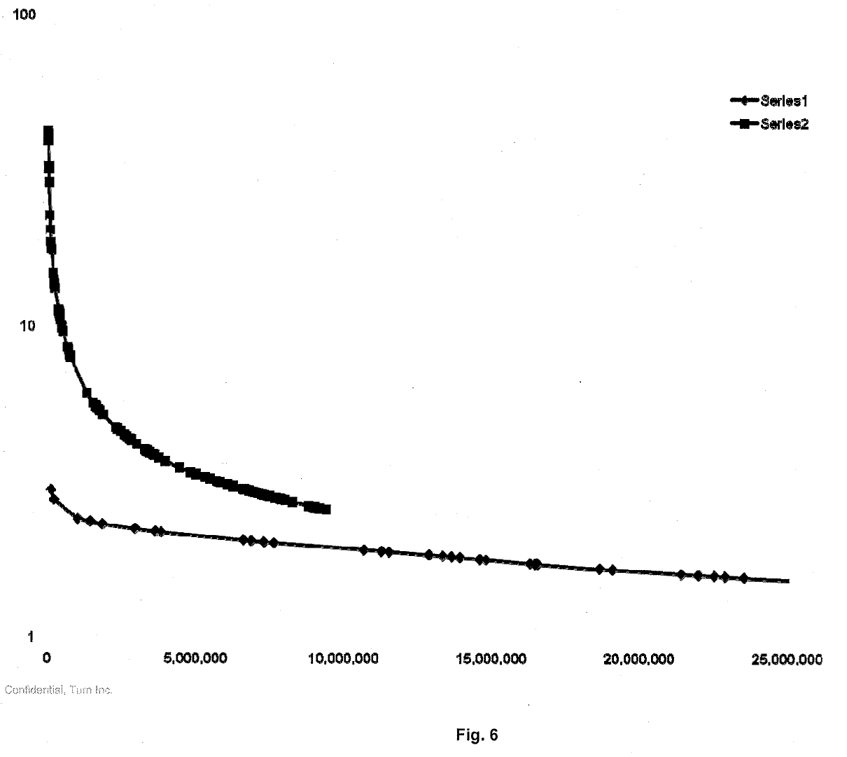

FIG. 6 is an illustration of lift plotted as a function of the target audience for a first and second pass through the optimization engine 200. Series 1 represents the single-variable pass. Series 2 is a multi-variable pass through the optimization engine 200. Series 2 shows a more rapid decrease in lift because the multiple variables in each segment cause a faster narrowing of the target audience.

A variable compression process is applied 460 to the selected variable list 240. The compression makes the rules more efficient and also more humanly readable. For example, if the rules include users that have searched for an item in the past 0-7 days, the past 7-14 days, and the past 14-30 days, the three rules are compressed into a single rule for users that have searched for an item in the past month. A rule conversion is applied to the selected variable list to generate 465 a behavior segment 345. The behavior segment 345 is saved 470 in the behavior segment database 305.

### Example 1

### Luxury SUV Brand XYZ Behavior segments

This behavior segment identifies people that are likely to purchase a Luxury SUV from Brand XYZ. The rules are therefore based on user interest in different types of motor vehicle categories. The information is gathered from Turn, DataSourceX, and DataSourceY who all track user behavior in different ways, including Internet activities, retail transactions, etc.

1. Turn Click Autos, Boats, & Cycles Auto Sales (freq=1+, 0-3 days)
2. DataSourceX (SUVs, 0-3 days) & DataSourceX (Land Rover, 0-3 days)
3. Turn Click Autos, Boats, & Cycles Auto Sales (freq=1+, 0-7 days)
4. DataSourceY (Young & Hip, 0-3 days)
5. DataSourceX (Audi_Q5, 0-14 days)
6. DataSourceX (Land Rover, 0-3 days)
7. DataSourceX (Audi_Q5, 0-30 days) & DataSourceX (Land Rover, 0-14 days)
8. Turn Click Autos, Boats, & Cycles Auto Sales (freq=1+, 0-14 days)
9. DataSourceX (Land Rover, 0-7 days)
10. DataSourceX (Luxury Cars, 0-3 days)
11. DataSourceY (Young & Hip, 0-7 days)
12. DataSourceX (Luxury Cars, 0-3 days) & DataSourceX (Mercedes-Benz, 0-3 days)

The lift decreases in descending order. The first rule identifies users that clicked on an ad for sales of autos, boats, and cycles more than once in the last 0-3 days. The second rule from DataSourceX identifies users that are interested in SUVs in the last three days and are also interested in the brand Land Rovers in the last three days. The third rule is the same as the first, except that the recency is increased to seven days. Because the first rule covers 0-3 days and has a higher lift than the rule for 0-7 days, users are only counted for the third rule if they clicked on auto sales from 4-7 days.

The fourth rule illustrates that the data is not simply about the category of products, but also how the product describes a facet of the user. In this case, the advertiser is more interested in the fact that the action is associated with a young and hip person than the product itself.

These behavior segments help identify groups of people in non-intuitive ways. For example, the largest purchaser of men's apparel is women because women do more household shopping than men. By limiting the behavior segment to a small list of simple rules, they are easier to interpret and easier for the system to process.

### Example 2

### Cell Phone Provider Behavior segments

In Example 2, the system determines that there is a connection between people that would click on a Cell Phone Provider ad and people interested in computers and the Internet, women's shoes, pregnancy, health, and gaming. The behavior segment reveals that rules relating to cellular telephones provide the smallest lift.

1. DataSourceX (Computers & Internet, 0-14 days)

### 2. Gender (Male) & Age (18-45)

3. DataSourceY (Women's Shoes, 0-14 days)
4. Publisher Partners (Careers or Health Pregnant, 0-14 days)
5. Publisher Partners (Apartment Ratings or Health, 0-14 days)
6. Turn Click Arts, Entertainment, & Hobbies Gaming (freq=1+, 0-90 days)
7. Turn Click Telecommunications Cellular Service (freq=1+, 0-90 days)
8. DataSourceZ (Search, Cell Phones & Smartphones, 0-90 days)
9. DataSourceZ (View, Cell Phones & Smartphones, 0-90 days)

### Example 3

### Online University Behavior segments

Example 3 is for an online University.

1. Age (18-45) & Turn Click Telecommunications (freq=1+, 0-30 days)
2. DataSourceX (College admissions, 0-14 days) & Gender (female)
3. DataSourceX (College admissions, 0-7 days)
4. DataSourceX (Financial aid, 0-30 days)
5. Gender (declared) & Publisher Partners (Apartment Ratings, 0-30 days)
6. DataSourceY (Toys: Big & Tall Apparel Buyers, 0-14 days)
7. Publisher Partners (Apartment Ratings, 0-30 days) & Age (30-45)
8. Publisher Partners (Apartment Ratings, 0-7 days)
9. Publisher Partners (That Rental Site, 0-14 days)
10. Turn Click Education Degrees (freq=1+, 0-3 days)
11. Turn Click Telecommunications Cellular Service (freq=1+, 0-7 days)
12. Turn Click Telecommunications (freq=1+, 0-90 days) & Gender (Female)

### Segment Refresh Process

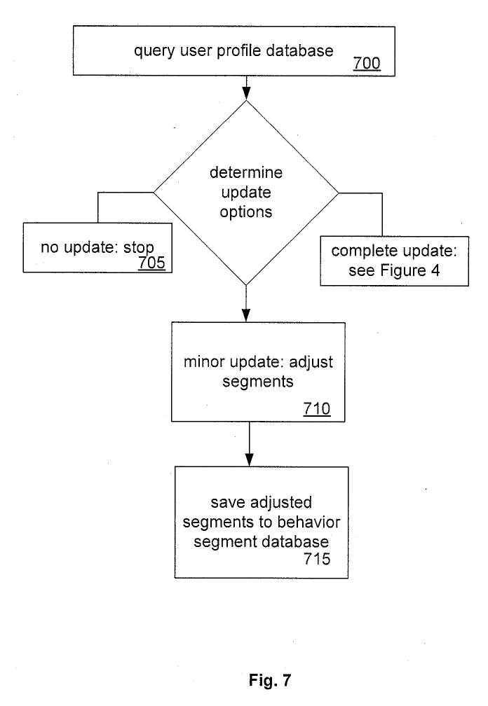

Once the behavior segments are generated, the information is updated through a segment refresh process. User activities change and because the system runs in real-time, the segments are updated frequently. FIG. 7 is a flow chart that illustrates the steps for refreshing the segments. The user profile database 300 is queried 700 to get rule-level performance. The user profile database 300 returns 705 a query result file, which contains the rule identification, the number of impressions, and the number of targeted users. The client 105 determines update options. Specifically, if a complete update is necessary, the client starts the process from FIG. 4. In one embodiment, a complete update is triggered when 20% of the data points have changed from the last time that the behavioral segments were saved to the behavior segment database 305. If no update is necessary, the process stops 705. If a minor update is needed, the adjusted segments are saved 710 to the behavior segment database 305.

### Runtime Ad Serving Process

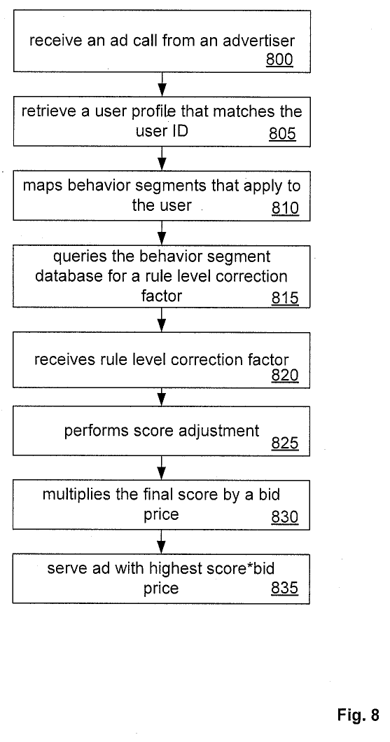

The process for determining which ad to serve during the runtime ad serving process is illustrated as a flow chart in FIG. 8. The client 105 receives 800 an ad call from a publisher. The ad call contains a user identification (ID) code for the user that will receive the ad. The client retrieves 805 a user profile that matches the user ID code. The user profile is retrieved from a browser cookie that resides on a user's computer or from a user profile database 300.

The client 105 maps 810 behavior segments that apply to the user. The behavior segments are used to predict the user's reactions to different advertisements. The client 105 queries 815 the behavior segment database 305 for a rule level correction factor. The correction factor adjusts the lift associated with each matching segment according to the behavior segment's position in the rule list for each advertisement. For example, if the user matches segments one and seven for Ad A, it may be a better predictor that the user will click on the ad than matching segments two and four for Ad B.

In one embodiment, the client 105 also incorporates other predictive models, such as the one described in U.S. patent application Ser. No. 12/410,400, which is herein incorporated by reference. These predictive models include global factors, such as the time of day and the user's location, which is derived from the IP address. The time of day is useful information because, for example, the user is more likely to buy cars and shoes in the evening than in the morning. Further, people that have finished dinner are less interested in purchasing food than entertainment devices, so advertisements served during mealtimes exclude food. Geography is important for refining some of the behavior segments. For example, young and hip is geographically defined such that young and hip in Silicon Valley uses different criteria than young and hip in Ohio. The location is also used to determine demographic information, such as the interests of people in a particular area, local Internet search terms, etc. The client 105 receives 820 the rule level correction factor.

A score adjustment process is performed 825 to output a likelihood score of positive user responses for each competing advertisement. The client 105 multiplies 830 the likelihood score by a bid price, i.e. the price that the advertiser provides as an expected value of a purchase or a lead for a purchase. The product of bid price and likelihood score represents the expected value of this ad call to the advertiser. As a result, the client serves 835 the ad with the highest score*bid price.

As will be understood by those familiar with the art, the invention may be embodied in other specific forms without departing from the spirit or essential characteristics thereof. Likewise, the particular naming and division of the members, features, attributes, and other aspects are not mandatory or significant, and the mechanisms that implement the invention or its features may have different names, divisions and/or formats. Accordingly, the disclosure of the invention is intended to be illustrative, but not limiting, of the scope of the invention, which is set forth in the following Claims.

1. A computer-implemented method for generating targeted behavior segments, the method comprising the steps of:
receiving, with a computer, a query for variables that are associated with any of a product, an advertisement, and a type of user;
retrieving, with the computer, a query result file that contains a variable list, a number of targeted users, and a number of non-targeted users;
retrieving, with the computer, a multi-variable result file comprising a recency for each variable, the combination of each variable and the recency forming a rule;
calculating, with the computer, a lift for each rule that defines a response rate of a targeted audience as compared to a response rate of a non-targeted audience;
generating, with the computer, a selected multi-variable list by optimizing a number of rules in the selected multi-variable list as a function of the lift and a target audience; and
generating a behavior segment from the selected multi-variable list.

2. The method of claim 1, further comprising the step of:
compressing the variables to make more efficient and readable rules.

3. The method of claim 1, wherein the variables are expressed as any of: a beacon, Boolean logic, a proxy, demographics, third-party events, and a composite of behavior segments.

4. The method of claim 1, further comprising before the step of retrieving a recency, the step of:
optimizing, with the computer, the query result file by calculating a lift for each variable that defines a response rate of a targeted audience as compared to a response rate of a non-targeted audience; and
generating a selected single-variable list by optimizing the variables as a function of the lift and a target audience.

5. The method of claim 1, wherein the step of generating the selected multi-variable list defines the number of targeted users according to a stopping criteria (KS):
KS=(Sₜ/Nₜ)−(Sₙ/Nₙ)
where Sₜ is the number of targeted users that responded positively to a product or advertisement, Nₜ is the number of targeted users overall, Sₙ is the number of non-targeted users that responded positively to a product or advertisement, and Nₙ is the overall non-targeted number of users.

6. The method of claim 1, further comprising the step of:
adding, with the computer, a frequency to the multi-variable result file.

7. The method of claim 1, further comprising the steps of:
querying, with the computer, the user profile database to obtain rule-level performance;
receiving, with the computer, a query result file comprising a rule identification, a number of impressions, and a number of users that were targeted;
determining, with the computer, whether a threshold level of data points are different from a last generation of behavior segments; and
responsive to the threshold being exceeded, starting at the first step of receiving a query.

8. The method of claim 1, further comprising the step of:
responsive to the threshold not being exceeded, performing, with the computer, not adjusting behavior segments.

9. A computer-implemented method for serving ads based on behavior segments, the method comprising the steps of:
receiving, with a computer, an ad call comprising a user identification;
retrieving, with the computer, a user profile for a user that matches the user identification;
mapping, with the computer, rules in each behavior segment associated with an advertisement that applies to the user;
receiving, with the computer, a rule level correction factor for each rule in the behavior segment as a function of the behavior segment's lift, the lift comprising a response rate of a targeted audience as compared to a response rate of a non-targeted audience;
performing, with the computer, a score adjustment process to output a final score for each advertisement;
multiplying, with the computer, the score for each advertisement by a bid price; and
serving, with the computer, the advertisement with the highest score multiplied by the bid price.

10. The method of claim 9, wherein the user profile is retrieved from any of a browser cookie and a user profile storage.

11. The method of claim 9, wherein the score adjustment process includes blending the outputs of other predictive models based on any number of variables not included in the behavior segment definition.

12. The method of claim 9, wherein the behavior segments comprise any of a beacon, Boolean logic, a proxy, and a composite of behavior segments.

13. The method of claim 9, wherein the behavior segment includes any of recency, frequency, and velocity.

14. A system for generating targeted behavior segments comprising:
a user profile database for storing variables comprising any of a search history, internet activities, and internet history, for storing user profiles that track a recency, frequency, and velocity of a user satisfying any of the variables, and for returning a query result file that includes a variable list, a number of targeted users, and a number of non-targeted users that is associated with a product, the combination of a variable and at least a recency of the variable being referred to as a behavior segment;
an optimization engine for calculating a lift for each variable in the query result file, the lift comprising a response rate of a targeted audience as compared to a response rate of a non-targeted audience and for generating a selected multi-variable list that optimizes a number of rules in the behavior segment as a balance between the lift and a target audience; and
a behavior segment database for storing the behavior segment.

15. The system of claim 14, wherein the behavior segments are adjusted in real-time in response to a threshold amount of data in the user profile database changing.

16. The system of claim 14, wherein the behavior segment database stores a rule level correction factor for each rule in the behavior segment as a function of the behavior segment's lift.

17. The system of claim 14, wherein the optimization engine applies a lift to each variable in the query result file and generates a selected single-variable list by optimizing a number of variables in the single-variable list as a balance between the lift and a target audience before the optimization engine generates a multi-variable list.

18. The system of claim 14, wherein the variables in the selected multi-variable list are converted into rules.

19. The system of claim 14, wherein the selected multi-variable is generated by using a stopping criteria (KS) to define the number of targeted users according to the following equation:
KS=(Sₜ/Nₜ)−(Sₙ/Nₙ)
where Sₜ is the number of targeted users that responded positively to a product or advertisement, Nₜ is the number of targeted users overall, Sₙ is the number of non-targeted users that responded positively to a product or advertisement, and Nₙ is the overall non-targeted number of users.

20. The system of claim 14, wherein the system is part of a parallel-processing system.
